(19) United States
(12) Patent Application Publication
(10) Pub. No.: US 2007/0064828 A1
(43) Pub. Date: Mar. 22, 2007

(54) Method and system for multiple input multiple output (MIMO) channel estimation

(76) Inventors: Carlos Horacio Aldana, Sunnyvale, CA (US); Rajendra T. Moorti, Mountain View, CA (US); Christopher Young, Cupertino, CA (US)

Correspondence Address: MCANDREWS HELD & MALLOY, LTD, 500 WEST MADISON STREET, SUITE 3400, CHICAGO, IL, 60661, US

(21) Appl. No.: 11/187,495

(22) Filed: Jul. 22, 2005

(51) Int. Cl. H04L 1/02

(52) U.S. Cl. 375/267

(57) ABSTRACT

Various aspects of a method for and system for multiple input multiple output (MIMO) channel estimation are presented. Aspects of a method for computing channel estimates in a radio frequency (RF) communications system may comprise decomposing a direct matrix computation into a plurality of constituent matrices, and jointly computing a plurality of channel estimates for a corresponding plurality of channel estimate streams received via a plurality of RF channels based on at least a portion of the plurality of constituent matrices. Aspects of a system for computing channel estimates in an RF communications system may comprise a receiver that decomposes a direct matrix computation into a plurality of constituent matrices, and jointly computes a plurality of channel estimates for a corresponding plurality of channel estimate streams received via a plurality of RF channels based on at least a portion of the plurality of constituent matrices.

### CROSS-REFERENCE TO RELATED APPLICATIONS/INCORPORATION BY REFERENCE

Not Applicable.

### FIELD OF THE INVENTION

Certain embodiments of the invention relate to wireless communications. More specifically, certain embodiments of the invention relate to a method and system for multiple input multiple output (MIMO) channel estimation.

### BACKGROUND OF THE INVENTION

An RF communications system may comprise a transmitter and a receiver that communicate via a radio frequency (RF) channel. The transmitter may encode information in a symbol that is transmitted via the RF channel. The transmitter may utilize a modulation type to encode information into a symbol, s. The modulation type may comprise a plurality of constellation points that represent distinct combinations of binary bits. The transmitter may encode information comprising binary bits of information by selecting a modulation type, and within the selected modulation type, selecting a constellation point to represent the binary bits of information. The transmitter may generate electrical signals corresponding to the constellation point that may comprise in-phase (I) and quadrature phase (Q) signals. The correlation between a constellation point and I and Q signals may comprise a mapping. The I and Q signals may be transmitted by the transmitter as an IQ signal via the RF channel.

The RF channel may distort the transmitted IQ signal from the transmitter such that, at the receiver, the received electrical signals I_{R} and Q_{R} may differ in magnitude and/or phase from the corresponding transmitted electrical signals I and Q. In addition, the RF channel may introduce noise into the signal.

A task for a receiver in achieving successful reception of information, via the RF channel, from the transmitter may comprise a plurality of steps to determine, based on a received I_{R}Q_{R} electrical signal, the binary bits, of information that were transmitted by the transmitter. One step may comprise detecting a symbol from the received I_{R}Q_{R} signal. The receiver may utilize a modulation type to decode the I_{R}Q_{R} signal. The receiver may utilize a corresponding modulation type to the modulation type utilized by the transmitter. The correlation between the electrical signals I_{R} and Q_{R} and a constellation point may comprise a demapping. Because the electrical signals I_{R} and Q_{R} at the receiver may differ from the corresponding electrical signals I and Q at the transmitter, the receiver may be unable to correlate the electrical signals I_{R} and Q_{R} to a constellation point. The receiver may utilize heuristics to demap the electrical signals I_{R} and Q_{R} to a constellation point. The selected constellation point may comprise an estimate, ŝ, of the symbol, s, that was transmitted by the transmitter.

One of the challenges in MIMO systems is that multiplicative scale factors that are applied to transmitted and received signals may be dependent upon the characteristics of the communications medium between the transmitting mobile terminal and the receiving mobile terminal. A communications medium, such as an RF channel between a transmitting mobile terminal and a receiving mobile terminal, may be represented by a system transfer function, h. The relationship between a time varying transmitted signal, x(t), a time varying received signal, y(t), and the systems function may be represented as shown in equation [1]:
y(t)=h×x(t)+n(t) equation[1]
where n(t) represents noise which may be introduced as the signal travels through the communications medium and the receiver itself. In MIMO systems, the elements in equation[1] may be represented as vectors and matrices. If a transmitting mobile terminal comprises M transmitting antenna, and a receiving mobile terminal comprises N receiving antenna, then y(t) may be represented by a vector of dimensions N×1, x(t) may be represented by a vector of dimensions M×1, n(t) by a vector of dimensions N×1, and h may be represented by a matrix of dimensions N×M. In the case of fast fading, the transfer function, h, may become an impulse response, h(t). Therefore, individual coefficients, hᵢⱼ (t), may become time varying in nature.

In MIMO systems that communicate according to specifications in IEEE resolution 802.11, the receiving mobile terminal may compute h(t) each time a frame of information is received from a transmitting mobile terminal based upon the contents of a preamble field in each frame. The computations that are performed at the receiving mobile terminal may constitute an estimate of the “true” values of h(t) and may be known as “channel estimates”. For a frequency selective channel there may be a set of h(t) coefficients for each tone that is transmitted via the RF channel. To the extent that ĥ(t), which may be referred to as the “channel estimate matrix”, changes with time and to the extent that the transmitting mobile terminal fails to adapt to those changes, information loss between the transmitting mobile terminal and the receiving mobile terminal may result.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for multiple input multiple output (MIMO) channel estimation, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary multiple input multiple output (MIMO) communications system that may be utilized in connection with an embodiment of the invention.

FIG. 2 is a block diagram of an exemplary MIMO transceiver system in accordance with an embodiment of the invention.

FIG. 3a illustrates an exemplary training sequence comprising two spatial streams and two transmitting antennas, which may be utilized in connection with an embodiment of the invention.

FIG. 3b is an exemplary illustration of cyclical shifted transmission.

FIG. 4 is a block diagram of system for MIMO channel estimation, in accordance with an embodiment of the invention.

FIG. 5 illustrates exemplary power transfer functions for an RF channel, in accordance with an embodiment of the invention.

FIG. 6 is a block diagram illustrating exemplary steps for MIMO channel estimation, in accordance with an embodiment of the invention.

### DETAILED DESCRIPTION OF THE INVENTION

Certain embodiments of the invention may be found in a method and system for multiple input multiple output (MIMO) channel estimation. Various embodiments of the invention may comprise a method for jointly determining a plurality of channel estimates. One aspect of the invention may comprise a method for computation of channel estimates by direct computation of a matrix that is utilized to process signals received at a receiver via at least a portion of a plurality of RF channels that were transmitted by a transmitter comprising a plurality of transmitting antennas. Another aspect of the invention may comprise a method for decomposition of the matrix into a plurality of constituent matrices that may be sequentially utilized to process signals received at the receiver via at least a portion of a plurality of RF channels that were transmitted by the transmitter comprising the plurality of transmitting antennas.

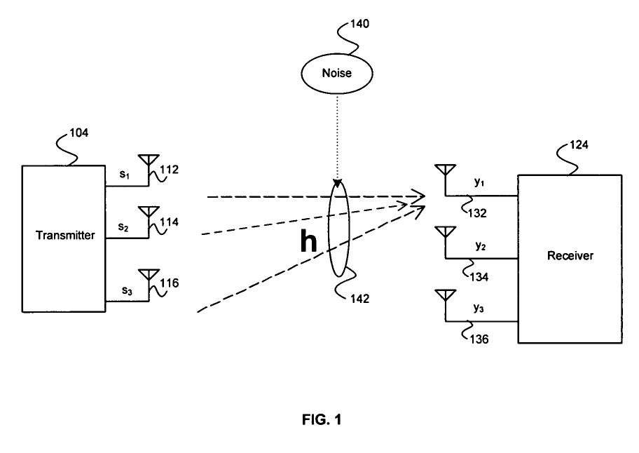

FIG. 1 is a block diagram illustrating an exemplary multiple input multiple output (MIMO) communications system that may be utilized in connection with an embodiment of the invention. Referring to FIG. 1 there is shown a transmitting mobile terminal 104, a plurality of transmitting antenna 112, 114, and 116, a receiving mobile terminal 124, a plurality of receiving antenna 132, 134, and 136, a plurality of RF channels 142, and a random noise source 140.

In operation, the transmitter 104 may transmit signals via the plurality of transmitting antennas 112, 114, and 116. A signal may comprise a transmitted symbol. An independent signal transmitted by the plurality of transmitting antennas 112, 114, and 116 may represent a spatial stream. A signal transmitted by a transmitter 104 may be considered independent if it comprises information that is unique with regard to another signal transmitted by the transmitter 104, during an approximately simultaneous period of time. For a given number, NTX, of transmitting antennas 112, 114, and 116, the number of spatial streams, NSS, transmitted by the transmitter 104 may be greater than or equal to 1, and less than or equal to NTX. If NSS is equal to NTX, then each of the plurality of transmitting antennas 112, 114, and 116 may transmit an independent signal during an approximately simultaneous period of time. If NSS is less than NTX, then at least one of the transmitting antennas 112, 114, and 116 may transmit information that is not independent from the information that is transmitted by at least one other of the transmitting antennas 112, 114, and 116 during an approximately simultaneous period of time.

The transmitter 104 may transmit a plurality of symbols s₁, s₂, and s₃, via corresponding transmitting antenna 112, 114, and 116 respectively. The symbols may be transmitted via an RF channel 142 where they may be subjected to scaling by a transfer function matrix, h, that is associated with transmission via the RF channel 142. A transfer function matrix, h, may be derived a receiver 124 based on a channel estimate. Furthermore, random noise from the random noise source 140 may be added to the transmitted symbols. In a communication with the transmitter 104, the receiver 124 may receive signals y₁, y₂, and y₃, via receiving antennas 132, 134, and 136 respectively, where at least one received signal comprises at least a portion of the symbols s₁, s₂, and s₃ that were transmitted by the transmitter 104. For example, given a memoryless channel, and independent signals from the transmitting antennas 112, 114, and 116, the signal y₁ may be expressed:
y₁ =h₁₁s₁+h₁₂s₂+h₁₃s₃+n₁ equation[2]
where n₁ may represent random noise introduced into the RF channel 142 by a random noise source 140, and hₙᵢ may represent a coefficient from the transfer function matrix h that is applied to a signal transmitted by transmitting antenna i, and received by receiving antenna n.

Equation[2] may be generalized to express a relationship between a plurality of signals, s, transmitted by a transmitter 104, utilizing a plurality of transmitting antennas, and a plurality of signals, y, received by a receiver 124, utilizing a plurality of receiving antennas:
y=hs+n equation[3]
where y={y₁, y₂, . . . y_{NRX}} may be represented as an NRX×1 (NRX rows, 1 column) vector with NRX representing a number of receiving antenna, s={x₁, x₂, . . . x_{NSS}} may be represented as an NSS×1 vector, h may be represented as a NRX×NSS matrix {{h₁₁, h₁₂, . . . h_{1,NSS}}{h₂₁, h₂₂, . . . h_{2,NSS}}{h_{NRX, 1}, h₃₂, h_{NRX,NSS}}}; and n may be represented as a NRX×1 vector {n₁, n₂ . . . . n_{NRX}}. In the exemplary MIMO communications system illustrated in FIG. 1, Y={y₁, y₂, y₃}, S={s₁, s₂, s₃}, H={{h₁₁, h₁₂, h₁₃}{h₂₁, h₂₂, h₂₃}{h₃₁, h₃₂, h₃₃}}; and N={n₁, n₂, n₃}.

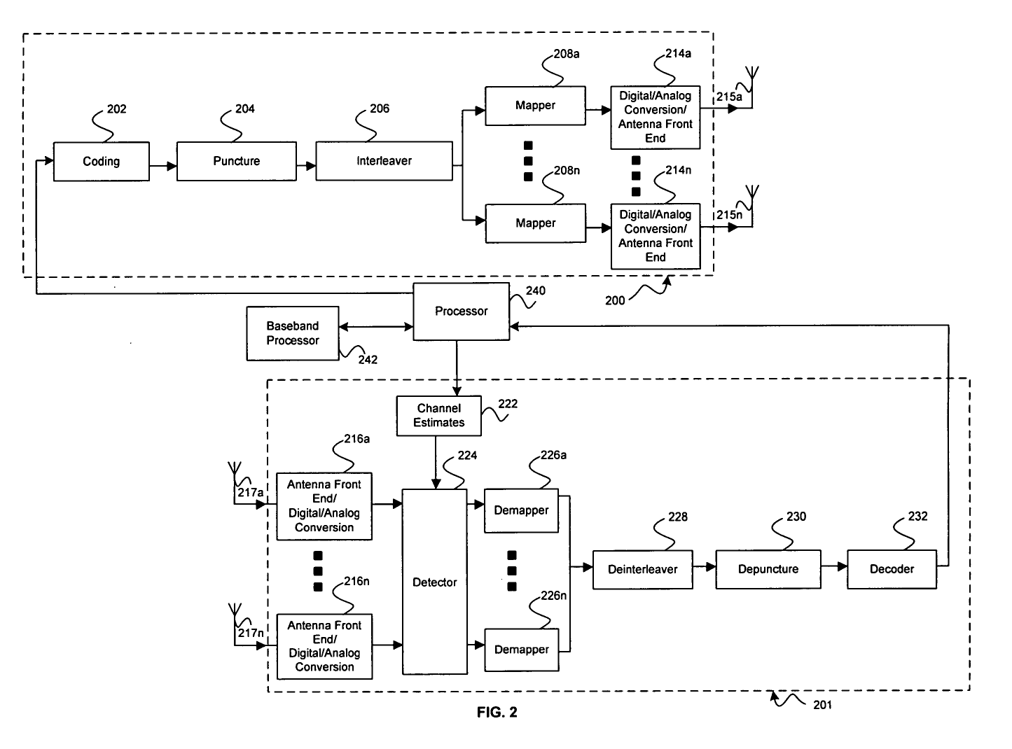

FIG. 2 is a block diagram of an exemplary MIMO transceiver system in accordance with an embodiment of the invention. Referring to FIG. 2 there is shown a transceiver comprising a transmitter 200, a receiver 201, a processor 240, a baseband processor 242, a plurality of transmitting antennas 215a . . . 215n, and a plurality of receiving antennas 217a . . . 217n. The transmitter 200 may comprise a coding block 202, a puncture block 204, an interleaver block 206, a plurality of mapper blocks 208a . . . 208n, and a plurality of digital to analog (D to A) conversion and antenna front end blocks 214a . . . 214n. The receiver 201 may comprise a plurality of antenna front end and analog to digital (A to D) conversion blocks 216a . . . 216n, a detector block 224, a plurality of demapper blocks 226a . . . 226n, a deinterleaver block 228, a depuncture block 230, and a decoder block 232.

The processor 240 may perform digital receiver and/or transmitter functions in accordance with applicable communications standards. These functions may comprise, but are not limited to, tasks performed at lower layers in a relevant protocol reference model. These tasks may further comprise a physical layer convergence procedure (PLCP), physical medium dependent (PMD) functions, and associated layer management functions. The baseband processor 242 may similarly perform functions in accordance with applicable communications standards. These functions may comprise, but are not limited to, tasks related to analysis of data received by the receiver 201, and tasks related to generating data to be transmitted by the transmitter 200. These tasks may further comprise medium access control (MAC) layer functions as specified by pertinent standards.

In the transmitter 200, the coding block 202 may transform received binary input data blocks by applying a forward error correction (FEC) technique, for example, binary convolutional coding (BCC). The application of FEC techniques, also known as “channel coding”, may improve the ability to successfully recover transmitted data at a receiver by appending redundant information to the input data prior to transmission via an RF channel. The ratio of the number of bits in a binary input data block to the number of bits in a transformed data block may be known as the “coding rate”. The coding rate may be specified using the notation i_{b}/t_{b}, where t_{b} represents the total number of bits that may comprise a coding group of bits, while i_{b} represents the number of information bits that may be contained in the group of bits t_{b}. Any number of bits t_{b}-i_{b} may represent redundant bits that may enable the receiver 201 to detect and correct errors introduced during transmission. Increasing the number of redundant bits may enable greater capabilities at the receiver to detect and correct errors in information bits. The invention is not limited to BCC, and any one of a plurality of coding techniques, for example, Turbo coding or low density parity check (LDPC) coding, may also be utilized.

The puncture block 204 may receive transformed binary input data blocks from the coding block 202 and alter the coding rate by removing redundant bits from the received transformed binary input data blocks. For example, if the coding block 202 implemented a ½ coding rate, 4 bits of data received from the coding block 202 may comprise 2 information bits, and 2 redundant bits. By eliminating 1 of the redundant bits in the group of 4 bits, the puncture block 204 may adapt the coding rate from ½ to ⅔. The interleaver block 206 may rearrange bits received in a coding rate-adapted data block from the puncture block 204 prior to transmission via an RF channel to reduce the probability of uncorrectable corruption of data due to burst of errors, impacting contiguous bits, during transmission via an RF channel. The output from the interleaver block 206 may also be divided into a plurality of streams where each stream may comprise a non-overlapping portion of the bits from the received coding rate-adapted data block. Therefore, for a given number of bits in the coding rate-adapted data block, b_{db}, a given number of streams from the interleaver block 206, nₛₜ, and a given number of bits assigned to an individual stream i by the interleaver block 206, bₛₜ(i):

$${b}_{db} = {\sum }_{i = 0}^{{n}_{st} - 1} {b}_{st} ( i ) \qquad equation [ 4 ]$$

For a given number of coded bits before interleaving, b_{db}, each bit may be denoted by an index, k=0, 1 . . . b_{db}−1. The interleaver block 206 may assign bits to the first spatial stream, spatial stream 0, bₛₜ(0), for bit indexes k=0, nₛₜ, 2*nₛₜ, . . . , b_{db}−nₛₜ. The interleaver block 206 may assign bits to spatial stream 1, bₛₜ(1), for bit indexes k=1, nₛₜ+1, 2*nₛₜ+1, . . . , b_{db}−nₛₜ+1. The interleaver block 206 may assign bits to spatial stream 2, bₛₜ(2), for bit indexes k=2, nₛₜ+2, 2*nₛₜ+2, . . . , b_{db}−nₛₜ+2. The interleaver block 206 may assign bits to spatial stream nₛₜ, bₛₜ(nₛₜ), for bit indexes k=nₛₜ−1, 2*nₛₜ−1, 3*nₛₜ−1, . . . , b_{db}−1.

The plurality of mapper blocks 208a . . . 208n may comprise a number of individual mapper blocks that is equal to the number of individual streams generated by the interleaver block 206. Each individual mapper block 208a . . . 208n may receive a plurality of bits from a corresponding individual stream, mapping those bits into a “symbol” by applying a modulation technique based on a “constellation” utilized to transform the plurality of bits into a signal level representing the symbol. The representation of the symbol may be a complex quantity comprising in-phase (I) and quadrature (Q) components. The mapper block 208a . . . 208n for stream i may utilize a modulation technique to map a plurality of bits, bₛₜ(i), into a symbol.

The plurality of digital (D) to analog (A) conversion and antenna front end blocks 214a . . . 214n may receive the plurality of signals generated by the plurality of mapper blocks 208a . . . 208n. The digital signal representation received from each of the plurality of mapper blocks 208a . . . 208n may be converted to an analog RF signal that may be amplified and transmitted via an antenna. The plurality of D to A conversion and antenna front end blocks 214a . . . 214n may be equal to the number of transmitting antenna 215a . . . 215n. Each D to A conversion and antenna front end block 214a . . . 214n may utilize an antenna 215a . . . 215n to transmit one RF signal via an RF channel.

In the receiver 201, the plurality of antenna front end and A to D conversion blocks 216a . . . 216n may receive analog RF signals via an antenna, converting the RF signal to baseband and generating a digital equivalent of the received analog baseband signal. The digital representation may be a complex quantity comprising I and Q components. The number of antenna front end and A to D conversion blocks 216a . . . 216n may be equal to the number of receiving antenna 217a . . . 217n.

The channel estimates block 222 may utilize preamble information, contained in a received RF signal, to compute channel estimates. The detector block 224 may receive signals generated by the plurality of antenna front end blocks 216a . . . 216n. The detector block 224 may process the received signals based on input from the channel estimates block 222 to recover the symbol originally generated by the transmitter 200. The detector block 224 may comprise suitable logic, circuitry, and/or code that may be adapted to transform symbols received from the plurality of antenna front end blocks 216a . . . 216n to compensate for fading in the RF channel.

The plurality of demapper blocks 226a . . . 226n may receive symbols from the detector block 224, reverse mapping each symbol to one or more binary bits by applying a demodulation technique, based on the modulation technique utilized in generating the symbol at the transmitter 200. The plurality of demapper blocks 226a . . . 226n may be equal to the number of streams in the transmitter 200.

The deinterleaver block 228 may receive a plurality of bits from each of the demapper blocks 226a . . . 226n, and rearrange the order of bits among the received plurality of bits. The deinterleaver block 228 may rearrange the order of bits from the plurality of demapper blocks 226a . . . 226n in, for example, the reverse order of that utilized by the interleaver 206 in the transmitter 200. The depuncture block 230 may insert “null” bits into the output data block received from the deinterleaver block 228 that were removed by the puncture block 204. The decoder block 232 may decode a depunctured output data block, applying a decoding technique that may recover the binary data blocks that were input to the coding block 202.

The processor 240 may receive decoded data from the decoder 232. The processor 240 may communicate received data to the baseband processor 242 for analysis and further processing. The processor 240 may also communicate data received via the RF channel, by the receiver 201, to the channel estimates block 222. This information may be utilized by the channel estimates block 222, in the receiver 201, to compute channel estimates for a received RF channel. The baseband processor 242 may generate data to be transmitted via an RF channel by the transmitter 200. The baseband processor 242 may communicate the data to the processor 240. The processor 240 may generate a plurality of bits that are communicated to the coding block 202.

The elements shown in FIG. 2 may comprise components that may be present in an exemplary embodiment of a wireless communications terminal. A wireless communications terminal may also be referred to as a mobile terminal. One exemplary embodiment may be a wireless communications transmitter comprising a transmitter 200, a processor 240, and a baseband processor 242. Another exemplary embodiment may be a wireless communications receiver comprising a receiver 201, a processor 240, and a baseband processor 242. Another exemplary embodiment may be a wireless communications transceiver comprising a transmitter 200, a receiver 201, a processor 240, and a baseband processor 242.

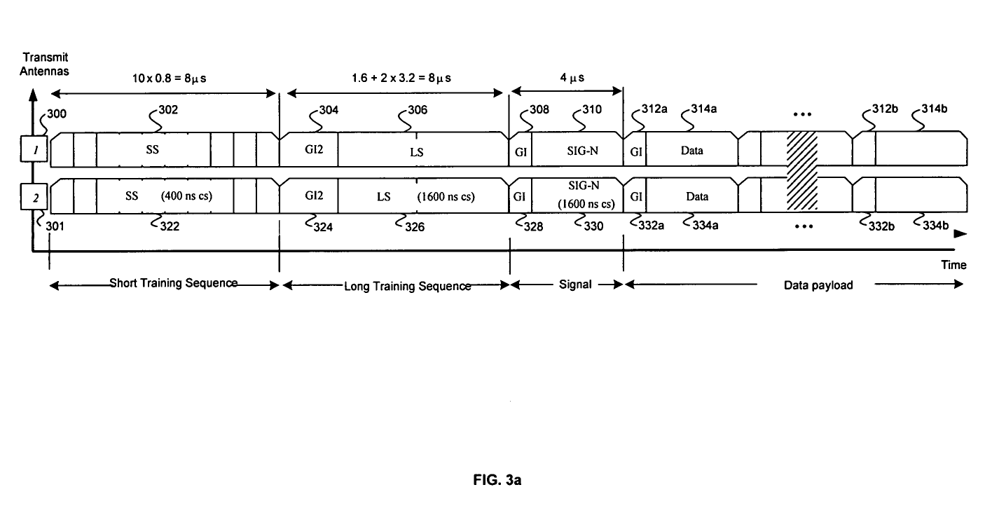

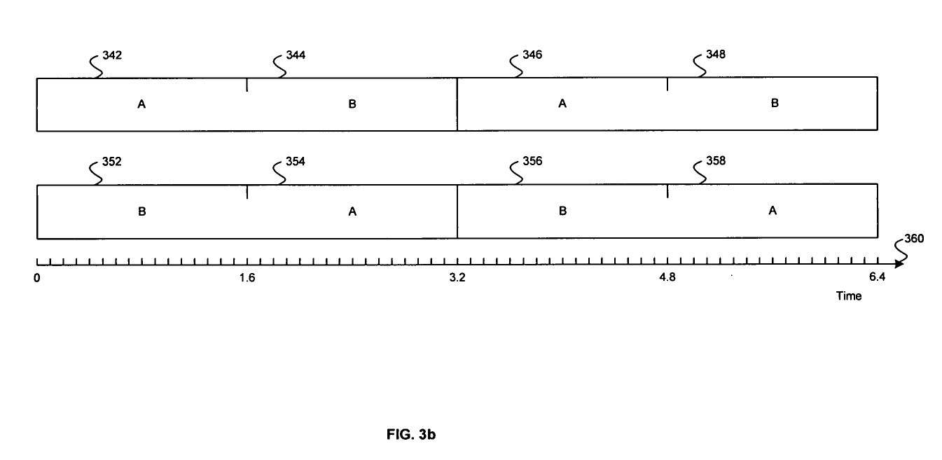

FIG. 3a illustrates an exemplary training sequence comprising two spatial streams and two transmitting antennas, which may be utilized in connection with an embodiment of the invention. With reference to FIG. 3a, there is shown a first antenna 300, and a second antenna 301. The physical layer protocol data unit (PPDU) transmitted by the first antenna 300 may comprise a short sequence field 302, a training symbol guard interval (GI2) field 304, a long sequence field 306, a guard interval (GI) field 308, a SIG-N field 310, a plurality of guard interval fields 312a . . . 312b, and a plurality of data fields 314a . . . 314b. The message transmitted by the second antenna 301 may comprise a short sequence field 322, a training symbol guard interval field 324, a long sequence field 326, a guard interval field 328, a SIG-N field 330, a plurality of guard interval fields 332a, . . . , 332b, and a plurality of data fields 334a, . . . , 334b.

A physical layer service data unit (PSDU) may comprise a header and a data payload. The preamble of the PSDU transmitted by the first antenna 300 may comprise a short sequence field 302, and a long sequence field 306. The header portion of the PSDU transmitted by the first antenna 300 may comprise the SIG-N field 310. The data payload of the PSDU transmitted by the first antenna 300 may comprise a plurality of data fields 314a, . . . , 314b. The preamble to the PSDU transmitted by the second antenna 301 may comprise a short sequence field 322, and a long sequence field 326. The header portion of the PSDU transmitted by the second antenna 301 may comprise the SIG-N field 330. The data payload of the PSDU transmitted by the second antenna 301 may comprise plurality of data fields 334a, . . . , 334b.

The short sequence field 302 may comprise a plurality of short training sequence symbols, for example, 10 short training sequence symbols. Each short training sequence symbol may comprise transmission of information for a defined time interval, for example, about 800 nanoseconds (ns). The duration of the short sequence field 302 may comprise a time interval, for example, about 8 microseconds (μs). The short sequence field 302 may be utilized by a receiver, for example, receiver 201, for a plurality of reasons. Exemplary utilizations may comprise signal detection, automatic gain control (AGC) for low noise amplification circuitry, diversity selection such as performed by rake receiver circuitry, coarse frequency offset estimation, and timing synchronization.

The training symbol guard interval field 304 may comprise a time interval during which the first antenna 300 may transmit redundant information via an RF channel. The duration of the training symbol guard interval field 304 may comprise a time interval, for example, about 1.6 μs. The training symbol guard interval field 304 may be utilized by a receiver, for example, receiver 201, to reduce the likelihood of inter-symbol interference between a preceding symbol, for example, a symbol transmitted during a short sequence field 302, and a succeeding symbol, for example, a symbol transmitted during a long sequence field 306.

The long sequence field 306 may comprise a plurality of long training symbols, for example NSS, or NTX long training symbols. Each long training symbol may comprise transmission of information for a defined time interval, for example, about 3.2 μs. The duration of the long training sequence, including the duration of the long sequence field 306, and the preceding training symbol guard interval field 304, may comprise a time interval of, for example, about 8 μs. The long training sequence field 306 may be utilized by a receiver, for example, receiver 201, for a plurality of reasons, for example, fine frequency offset estimation, and channel estimation.

The guard interval field 308 may comprise a time interval during which the first antenna 300 may transmit redundant information via an RF channel. The duration of guard interval field 308 may comprise a time interval, for example, about 800 ns. The guard interval field 308 may be utilized by a receiver, for example, receiver 201, to reduce the likelihood of inter-symbol interference between a preceding symbol, for example, a symbol transmitted during a long sequence field 306, and a succeeding symbol, for example, a symbol transmitted during the signal SIG-N field 310.

The signal SIG-N field 310 may comprise, for example, a signal symbol. Each signal symbol may comprise information transmitted during a defined time interval, for example, about 3.2 μs. The duration of the single symbol, including the duration of the signal SIG-N field 310, and the preceding guard interval field 308, may comprise a time interval, for example, about 4 μs. The signal SIG-N field 310 may be utilized by a receiver, for example, receiver 201, to establish a plurality of configuration parameters associated with receipt of a physical layer service data unit (PSDU) via an RF channel.

The guard interval field 312a may comprise a time interval during which the first antenna 300 may transmit redundant information via an RF channel. The duration of guard interval field 312a may comprise a time interval, for example, about 800 ns. The guard interval field 312a may be utilized by a receiver, for example, receiver 201, to reduce the likelihood of inter-symbol interference between a preceding symbol, for example, a symbol transmitted during a signal SIG-N field 310, and a succeeding symbol, for example, a symbol transmitted during a the data field 314a. Each successive guard interval field in the plurality of guard interval fields 312a, . . . , 312b may be utilized by a receiver, for example, receiver 201, to reduce the likelihood of inter-symbol interference between a preceding symbol, for example, a symbol transmitted during the plurality of data fields 314a, . . . , 314b, and a succeeding symbol in the plurality of data fields 314a, . . . , 314b.

A data field in the plurality of data fields 314a, . . . , 314b may comprise, for example, a data symbol. Each data symbol may comprise transmission, by the first antenna 300, of information for a defined time interval, for example, about 3.2 μs. The duration of each data interval, including the duration of a data field in the plurality of data fields 314a, . . . , 314b, and the preceding guard interval field in the plurality of guard interval fields 312a, . . . , 312b, may comprise a time interval, for example, about 4 μs. The plurality of data fields 314a, . . . , 314b may be utilized by a receiver, for example, receiver 201, receive information that is contained in a PSDU data payload received via an RF channel.

The short sequence field 322, training symbol guard interval field 324, long sequence field 326, guard interval 328, and signal SIG-N field 330 may comprise time shifted, or cyclically shifted, representations of the corresponding short sequence field 302, training symbol guard interval field 304, long sequence field 306, guard interval 308, and/or signal SIG-N field 310. The start of transmission of the cyclically shifted version short sequence field 322 by the second antenna 301 may precede the start of transmission of the short sequence field 302 by the first antenna 300 by an interval, for example, 400 ns. The start of transmission of the cyclically shifted version long sequence field 326 by the second antenna 301 may precede the start of transmission of the long sequence field 306 by the first antenna 300 by an interval, for example, 1600 ns. The start of transmission of the cyclically shifted version signal SIG-N field 330 by the second antenna 301 may precede the start of transmission of the signal SIG-N field 310 by the first antenna 300 by an interval, for example, about 1600 ns.

The guard interval field 332a may comprise a time interval during which the second antenna 301 may transmit redundant information via an RF channel. The duration of guard interval field 332a may comprise a time interval, for example, about 800 ns. The guard interval field 332a may be utilized by a receiver, for example, receiver 201, to reduce the likelihood of inter-symbol interference between a preceding symbol, for example, a symbol transmitted during a signal SIG-N field 330, and a succeeding symbol, for example, a symbol transmitted during a the data field 334a. Each successive guard interval field in the plurality of guard interval fields 332a, . . . , 332b may be utilized by a receiver, for example, receiver 201, to reduce the likelihood of inter-symbol interference between a preceding symbol, for example, a symbol transmitted during the plurality of data fields 334a, . . . , 334b, and a succeeding symbol in the plurality of data fields 334a, . . . , 334b.

The data field in the plurality of data fields 334a . . . 334b may comprise, for example, a data symbol. Each data symbol may comprise transmission, by the second antenna 301, of information for a defined time interval, for example, about 3.2 μs. The duration of each data interval, including the duration of a data field in the plurality of data fields 334a, . . . , 334b, and the preceding guard interval field in the plurality of guard interval fields 332a, . . . , 332b, may comprise a time interval, for example, about 4 μs. The plurality of data fields 334a, . . . , 334b may be utilized by a receiver, for example, receiver 201, receive information that is contained in a PSDU data payload received via an RF channel. The short sequence field 302, and the long sequence field 306, are specified in IEEE resolution 802.11.

In operation, short sequence and long sequence fields may be transmitted by the first antenna 300, of a transmitter, for example, transmitter 200, and received by a receiver, for example, receiver 201. For example, the receiver may compare a received long sequence field against the well known expected values to determine an extent to which transmission impairments may exist in an RF channel. Channel estimates may be derived for the RF channel. The channel estimates may comprise SNR information and may comprise information about individual spatial streams that may be transmitted via the RF channel.

The short sequence field 322, and the long sequence field 326, are specified in IEEE resolution 802.11. The short sequence and long sequence fields may be transmitted by the second antenna 301, of a transmitter, for example, transmitter 200, and received by a receiver, for example, receiver 201. For example, the receiver may compare a received long sequence field against known expected values to determine an extent to which transmission impairments may exist in an RF channel, and therefore, to derive channel estimates for the RF channel. The channel estimates may comprise SNR information and may comprise information about individual spatial streams that may be transmitted via the RF channel.

The preamble portion and header portion of the PSDU transmitted by the first antenna 300 may be transmitted utilizing a known modulation type and coding rate. The utilization of a known modulation type and coding rate may enable a transmitter, for example, transmitter 200, and a receiver, for example, receiver 201, to communicate until modulation type and coding rate information has been exchanged. The modulation type may comprise binary phase shift keying (BPSK), for example. The coding rate may be represented as ½. The modulation type and coding rate may represent the lowest data rate at which data may be transmitted via a spatial stream in an RF channel. The header transmitted by the first antenna comprising the signal SIG-N field 310, and the plurality of data fields 314a . . . 314b, may comprise a physical layer protocol data unit (PPDU).

The preamble portion and header portion of the PSDU transmitted by the second antenna 301 may be transmitted utilizing a particular modulation type and coding rate. The utilization of a particular modulation type and coding rate may enable a transmitter, for example, transmitter 200, and a receiver, for example, receiver 201, to communicate until modulation type and coding rate information has been exchanged. The modulation type may comprise binary phase shift keying (BPSK). The coding rate may be represented as ½. The modulation type and coding rate may represent the lowest data rate at which data may be transmitted via a spatial stream in an RF channel. The header transmitted by the first antenna comprising the signal SIG-N field 330, and the plurality of data fields 334a . . . 334b, may comprise a PPDU.

FIG. 3b is an exemplary illustration of cyclical shifted transmission. With reference to FIG. 3b there is shown a first block in a first long sequence field 342, a second block in the first long sequence field 344, a third block in the first long sequence field 346, a fourth block in the first long sequence field 348, a first block in a second long sequence field 352, a second block in the second long sequence field 354, a third block in the second long sequence field 356, and a fourth block in the second long sequence field 358. Also shown in FIG. 3b is an exemplary time scale 360. The first long sequence field comprising blocks 342, 344, 346, and 348 may represent a long sequence field 306 that is transmitted by a first antenna 300. The second long sequence field comprising blocks 352, 354, 356, and 358 may represent a long sequence field 326 that is transmitted by a second antenna 301. The time scale 360 may represent relative time units.

Block 342 may represent a long training subsequence, A, transmitted during a time interval from about 0 to about 1.6 time units. Block 344 may represent the long training subsequence, A, transmitted during a time interval from about 1.6 to about 3.2 time units. Block 346 may represent a long training subsequence, A, transmitted during a time interval from about 3.2 to about 4.8 time units. Block 348 may represent the long training subsequence, B, transmitted during a time interval from about 4.8 to about 6.4 time units. A long training symbol may comprise blocks 342 and 344, 346 and 348, 352 and 354, or 356 and 358, respectively.

Blocks 352 and 354 may represent a cyclically phase shifted version of the long sequence blocks 342 and 344, comprising a cyclical time shift interval of about 1.6 time units. Blocks 356 and 358 may represent a cyclically phase shifted version of the long sequence blocks 346 and 348, comprising a cyclical time shift interval of about 1.6 time units. The blocks 342, 344, 346, and 348 may be transmitted during the long sequence field 306 (FIG. 3a). The blocks 352, 354, 356, and 358 may be transmitted during the long sequence field 326 (FIG. 3a).

In an exemplary MIMO system comprising a transmitter 200 that utilizes at least 2 transmitting antennas 215a . . . 215n that transmit 2 spatial streams, and a receiver 201 that utilizes a plurality of receiving antennas 217a . . . 217n, a received signal, Yᵢ, received by a receiving antenna 217a from among the plurality of receiving antennas 217a . . . 217n, may be expressed as:

$${Y}_{i} ( k , t ) = {\sum }_{j = 1}^{NTX} {H}_{ij} ( k , t ) {X}_{j} ( k , t ) + {N}_{i} ( k , t ) \qquad equation [ 5 ]$$

where k may represent a frequency of a received signal, Yᵢ(k,t) may represent the received signal Yᵢ at a time instant, t, and at a frequency represented by k. The term Xⱼ (k,t) may represent a signal transmitted by an j^{th} transmitting antenna 215a at a time instant t, and at a frequency represented by k. The term Hᵢⱼ(k,t) may represent a transfer function in an RF channel for a signal transmitted by a j^{th} transmitting antenna, at a time instant t, at a frequency represented by k, and received by an i^{th} receiving antenna. The term Nᵢ(k,t) may comprise an additive Gaussian white noise (AWGN) profile at a time instant t.

In some preambles, the orthonormal relationship between long sequences, for example long sequence fields 306 and 326, may be more complex. In an exemplary MIMO system, the long sequence field 306 may comprise the subsequence, A(k), 342 (FIG. 3b) during the first about 1.6 time units of the time interval T_{LP}, and the subsequence, A(k), 344 during the subsequent about 1.6 time units of the time interval T_{LP}, for example. The long sequence field 326 may comprise the subsequence, A(k)(−1)^{k}, 352 (FIG. 3b) during the first about 1.6 time units of the time interval T_{LP}, and comprise the subsequence, A(k)(−1)^{k}, 354 during the subsequent about 1.6 time units of the time interval T_{LP}, for example.

In a MIMO system comprising a transmitter 200 that utilizes a plurality of NTX transmitting antennas 215a . . . 215n, where at least a portion of the transmitting antennas transmits a symbol comprising a plurality of Num_tones frequencies, and a receiver 201 that receives a signal Yᵢ, via an RF channel, utilizing an i^{th} receiving antenna 217a, the frequency domain signal Yi may be represented:

$${Y}_{i} = {\sum }_{j = 1}^{NTX} {X}_{j} {Wh}_{ij} + {N}_{i} \qquad equation [ 6 ]$$

where W may represent an FFT matrix of dimensions (number of rows ×number of columns) Num_tones×L, where L may represent a number of taps expected in the channel response 142. The term Xⱼ may represent a signal transmitted by the j^{th} transmitting antenna comprising a diagonal matrix of dimensions Num_tones×Num_tones. The term hᵢⱼ may represent a transfer function vector of dimensions L×1 in an RF channel for a signal transmitted by the j^{th} transmitting antenna and received by the i^{th} receiving antenna. The term Nᵢ may represent an AWGN matrix of dimensions Num_tones×1 comprising noise from the RF channel and received by the i^{th} receiving antenna. The transfer function vector hᵢⱼ may comprise a time domain representation of hᵢⱼ (k).

Equation[6] may also be represented:
Yᵢ=XQh+Nᵢ equation[7]
where X may represent a matrix of dimensions Num_tones×(Num_tones*NTX) that comprises a plurality of signals transmitted by the NTX transmitting antennas. The term Q may represent a block diagonal matrix of dimensions (Num_tones*NTX)×(L*NTX), which comprises a plurality of FFT matrices in association with the NTX transmitting antennas. The term h may represent a vector of dimensions (L-NTX)×1 that comprises a plurality of transfer functions in association with signals transmitted via the RF channel by the NTX transmitting antennas. The transfer function vector h may comprise a plurality of time domain representations hᵢⱼ of the transfer function for the RF channel.

In an exemplary embodiment of the invention, the RF channel may comprise a 40 MHz bandwidth, in which transmitted symbols may comprise a plurality of 112 frequencies, the transmitter 200 may utilize NTX=2 transmitting antennas 215a, and a channel 142 that may utilize 32 taps. In this exemplary embodiment of the invention, the dimensions of the matrix X may be 112×224, the dimensions of the matrix Q are 224×64, and the dimensions of the matrix h may be 64×1.

In some approaches to channel estimation, a least squares method may be utilized to compute a least squares channel estimate, ĥi,_{LS}, of the transfer function matrix h from equation[7] by matrix inversion:
ĥ_{i,LS}=(Q^{H}X^{H}XQ)⁻¹Q^{H}X^{H}Yᵢ equation[8]
where the notation G^{H} may represent an Hermitian transpose of the matrix G.

In various embodiments of the invention, a minimum mean squared error (MMSE) method may be utilized to compute an MMSE channel estimate, ĥ_{i,MMSE}, of the transfer function matrix h from equation[7]:
ĥ_{i,MMSE}=E(hᵢYᵢ^{H})E(YᵢYᵢ^{H})⁻¹Yᵢ equation[9]
which may be expressed:
ĥ_{i,MMSE}=Cₕ_{ᵢ}Q^{H}X^{H}(C_{N}+XQCₕ_{ᵢ}Q^{H}X^{H})⁻¹Yᵢ equation[10]
and may be further expressed:

$${\hat{h}}_{i , MMSE} = \underbrace{{( {C}_{h i}^{- 1} + {Q}^{H} {X}^{H} {C}_{N}^{- 1} XQ )}^{- 1}}_{CMI} {Q}^{H} {X}^{H} {C}_{N}^{- 1} {Y}_{i} \qquad equation [ 11 ]$$

where C_{h,i} may equal E(hihi^{H}), and C_{N} may equal E(NᵢNᵢ^{H}). C_{N} may represent the variance of the AWGN, Nᵢ, from equation[7], and may be approximately equal to σᵢ²I, where I may represent an identity matrix. The term labeled CMI from equation[11] may represent a correlation matrix inverse.

Since I may represent an identity matrix, and since σᵢ² may be approximately equal to 1 for AWGN, equation[11] may be simplified:

$${\hat{h}}_{i , MMSE} = \underbrace{{( {C}_{{h}_{i}}^{- 1} + {Q}^{H} {X}^{H} XQ )}^{- 1}}_{CMI} {Q}^{H} {X}^{H} {Y}_{i} \qquad equation [ 12 ]$$

In various embodiments of the invention the variance σᵢ² may not be limited to a value approximately equal to 1.

The transfer function H may comprise a plurality of frequency domain representations hᵢⱼ of the transfer function for the RF channel. Various methods of channel estimation may compute an estimate of the transfer function H. For example, based on the time domain channel estimate ĥ_{i,MMSE} from equation[11], the frequency domain channel estimate Ĥ_{i,MMSE} may be represented:
Ĥ_{i,MMSE}=Qĥ_{i,MMSE} equation[13]

In various embodiments of the invention, MIMO channel estimates for a plurality of RF channels may be jointly computed in the receiver 201 by the channel estimates block 222. Various aspects of the invention may comprise processing a received signal Yᵢ to generate a frequency domain channel estimate Ĥ_{i,MMSE}. One aspect of the invention may comprise direct matrix computation in which a matrix M is computed:
M=Q(Cₕᵢ⁻¹+Q^{H}X^{H}XQ)⁻¹Q^{H}X^{H} equation[14]
The computed matrix M may then be utilized to compute the frequency domain channel estimate:
Ĥ_{i,MMSE}=MYᵢ equation[15]

Another aspect of the invention may comprise decomposition of the matrix M into a plurality of constituent matrices that may be utilized to sequentially process a received Yᵢ. One aspect of decomposition may reduce complexity in various embodiments of the invention. In one embodiment of the invention, a frequency domain channel estimate Ĥ_{i,MMSE} may be generated by processing a matrix representing a received signal Yᵢ by a matrix represented by a match filter X^{H} to generate a first intermediate result. The first intermediate result may be subsequently processed by a matrix represented by Q^{H} to generate a second intermediate result. The second intermediate result may be processed by a matrix representing CMI from equation[12] to generate a time domain channel estimate ĥ_{i,MMSE}. The time domain channel estimate ĥ_{i,MMSE} may be subsequently processed by a matrix represented by Q to generate a frequency domain channel estimate Ĥ_{i,MMSE}. As the variance σᵢ² approaches a value of 0, the MMSE solution (as represented in equation[15]) may converge to a least squares solution.

Various embodiments of the invention may not be limited in the number of decompositions that may be utilized in various aspects of the invention. In various embodiments of the invention, a channel estimate, represented in the time domain by the time domain channel estimate ĥ_{i,MMSE}, and in the frequency domain by the frequency domain channel estimate Ĥ_{i,MMSE}. Various embodiments of the invention may be utilized to generate a time domain channel estimate ĥ_{i,MMSE}, or to generate a frequency domain channel estimate Ĥ_{i,MMSE}, that jointly comprises transfer functions hᵢⱼ for a plurality of RF channels utilized to transmit signals by a plurality of transmitting antennas, and received by a plurality of receiving antennas in a MIMO communications system. The invention may not be limited to the MMSE method in application of a direct matrix computation method, or of a decomposition method to the generation of MIMO channel estimates that comprise a time domain channel estimate ĥ_{i,MMSE}, and/or a frequency domain channel estimate Ĥ_{i,MMSE}. Accordingly, other computation and estimation methods may be utilized without departing from the spirit of the invention.

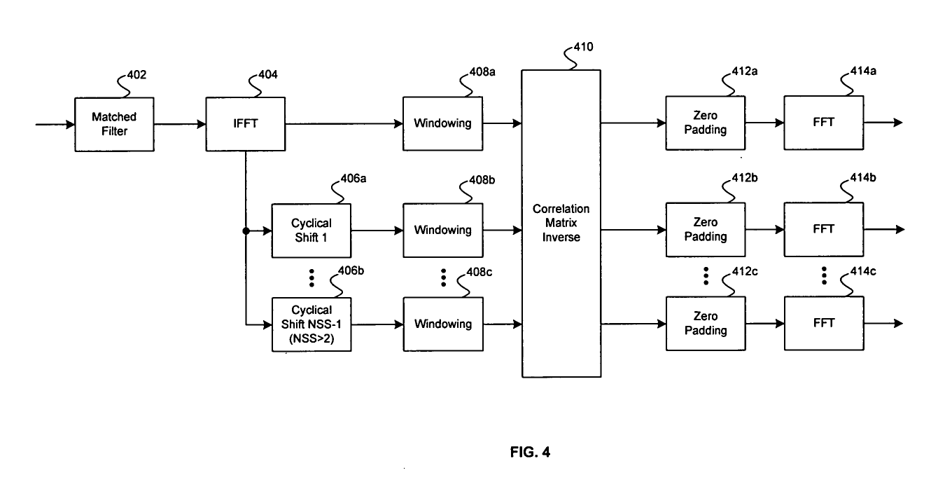

FIG. 4 is a block diagram of system for MIMO channel estimation, in accordance with an embodiment of the invention. Referring to FIG. 4, there is shown a matched filter (MF) block 402, an IFFT filter block 404, a plurality of cyclical shift blocks 406a . . . 406b, a plurality of windowing blocks 408a, 408b . . . 408c, a correlation matrix inverse (CMI) block 410, a plurality of zero padding blocks 412a, 412b . . . 412c, and a plurality of FFT blocks 414a, 414b . . . 414c. The block diagram in FIG. 4 may present an exemplary channel estimates block 222 in a receiver 201.

The MF block 402 may process the received signal Y, comprising a plurality of signals received by a plurality of receiving antennas 217a . . . 217n, by utilizing a matrix Xⱼ^{H}, to generate an intermediate result. The MF block 402 may process the received signal Y to select a signal that was transmitted by the j^{th} transmitting antenna 215a . . . 215n in the transmitter 200. The selected signal may comprise a long sequence field 306. The IFFT block 404 may process the intermediate result from the MF block 402 by utilizing a portion of the matrix Q^{H} to perform an IFFT on the intermediate result to generate a subsequent time domain signal.

Each of the plurality of cyclical shift blocks 406a . . . 406b may generate a cyclically shifted version of the subsequent time domain signal generated by the IFFT block 404. A cyclical shift block 406a may generate a cyclically shifted version of the subsequent time domain signal that corresponds to a cyclically shifted long sequence field 326 (FIG. 3a). For a MIMO communications system in which a transmitter transmits a plurality of NSS spatial streams, one of a plurality of NSS−1 cyclical shift blocks 406a . . . 406b may be utilized to generate a cyclically shifted version of a long sequence field 306 that corresponds to a cyclically shifted long sequence field 326 transmitted by the transmitter 200. In various embodiments of a MIMO communications system a transmitter may transmit a plurality of NSS=NTX spatial streams utilizing transmitting antennas 215a . . . 215n.

Each of the plurality of windowing blocks 408a, 408b . . . 408c, may process a subsequent time domain signal generated by the IFFT block 404, or a cyclically shifted version generated by a one of the plurality of cyclical shift blocks 406a . . . 406b, by utilizing a portion of the matrix Q^{H} to implement a digital filter comprising a plurality of L number of taps.

The CMI block 410 may process signals generated by the plurality of windowing blocks 408a, 408b . . . 408c, to generate a time domain channel estimate, ĥ_{i,MMSE}. The time domain channel estimate, ĥ_{i,MMSE}, may jointly comprises channel estimates for a plurality of RF channels utilized to transmit RF signals transmitted by a plurality of transmitting antennas 215a . . . 215n, and received by at least one receiving antenna 217a at a receiver 201.

Each of the plurality of zero padding blocks 412a, 412b . . . 412c, may process a time domain channel estimate for an RF channel generated by the CMI block 410 to generate a formatted time domain estimate. Each of the plurality of zero padding blocks 412a, 412b . . . 412c may format a time domain estimate by modifying the dimensions of the matrix representing the time domain estimate as a result of the insertion of numerical zeros into the matrix.

Each of the plurality of FFT blocks 414a, 414b . . . 414c may process a formatted time domain estimate by utilizing the matrix Q to generate a frequency domain estimate that represents at least a portion of a frequency domain channel estimate Ĥ_{i,MMSE} that comprises a channel estimate for one of a plurality of RF channels utilized to transmit RF signals transmitted by one of a plurality of transmitted antenna 215a . . . 215n, and received by one of at least one receiving antenna 217a at a receiver 201.

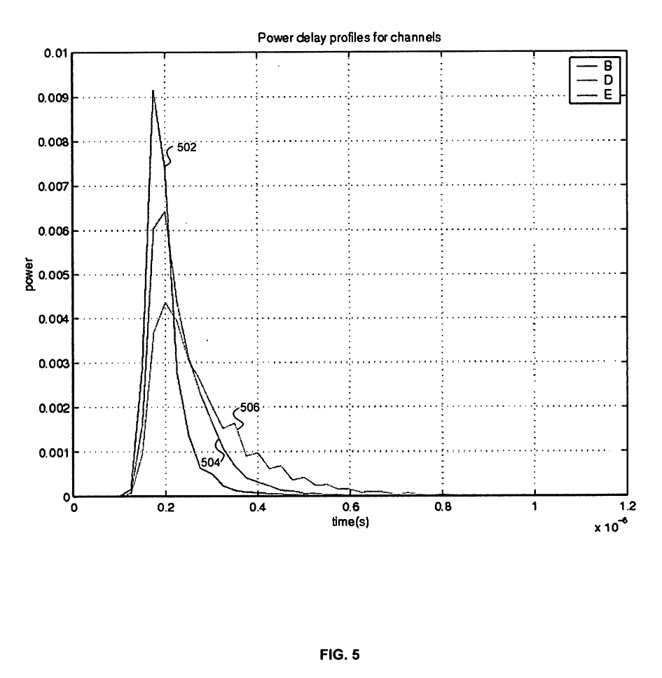

FIG. 5 illustrates exemplary power transfer functions for an RF channel, in accordance with an embodiment of the invention. Referring to FIG. 5a there is shown a power delay profile (PDP) for an IEEE 802.11-defined B channel 502, a PDP for an IEEE 802.11-defined D channel 504, and a PDP for an IEEE 802.11-defined E channel 506. The PDPs 502, 504, and 506, may represent received RF channel powers that have been excited via at least one of a plurality of RF transmitters, and processed by a digital filter in the receiver 201. The at least one of a plurality of RF channels may comprise a 20 MHz bandwidth. A PDP from among the plurality of PDPs 502, 504, and 506 may correspond to a channel covariance, which may be represented by a matrix Cₕ in equations [14], [15], [16], and [18], and utilized to generate a channel estimate for the corresponding RF channel. For each PDP 502, 504, and 506, a channel length Ls may be defined in time units that represents an earlier time instant at which the a value for the corresponding PDP first became greater than approximately 0, and a later time at which the value for the corresponding PDP subsequently becomes approximately 0. For the PDP 502, the channel length may be approximately 0.35 microseconds. For the PDP 504, the channel length may be approximately 0.4 microseconds. For the PDP 506, the channel length may be approximately 0.6 microseconds. When receiving over a bandwidth of B MHz, the estimated length of the channel, L, can be written as L=Ls*B.

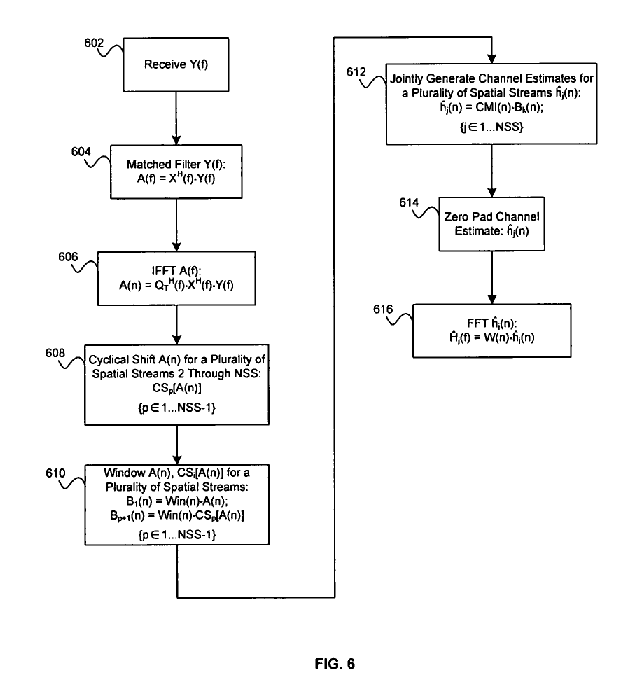

FIG. 6 is a block diagram illustrating exemplary steps for MIMO channel estimation, in accordance with an embodiment of the invention. Referring to FIG. 6, in step 602 a frequency domain signal Y(f) may be received by a receiver 201. The signal Y(f) may comprise signals transmitted via a plurality of RF channels by a transmitter 200, utilizing a plurality of transmitting antennas 215a . . . 215n, and received by a receiver 201, utilizing at least one receiving antenna 217a . . . 217n. Step 604 may comprise processing the signal Y(f) by a matched filter that generates a frequency domain signal A(f). The matched filter may generate the signal A(f) by selecting a signal transmitted by one of the plurality of transmitting antennas 215a . . . 215n. Step 606 may process the frequency domain signal A(f) to generate a time domain signal A(n).

Step 608 may generate at least one cyclically shifted version of the time domain signal A(n), CSᵢ[A(n)], that corresponds to a signal transmitted by at least one of the plurality of transmitting antennas 215a . . . 215n. A cyclically shifted signal may represent one of NSS−1 cyclically shifted signals that may be transmitted by at least one of a plurality of transmitting antennas 215a . . . 215n. Step 610 may apply windowing to digitally filter at least one of a time domain signal A(n), at least one cyclically shifted time domain signal CSₚ[A(n)]. Step 612 may jointly generate time domain channel estimates, ĥᵢⱼ(n), for a plurality of spatial streams transmitted by at least one of a plurality of transmitting antennas 215a . . . 215n. The number of time domain channel estimates may equal the number of spatial streams transmitted, NSS. Step 614 may zero pad a time domain channel estimate ĥᵢⱼ(n). Step 616 may process the time domain channel estimate ĥᵢⱼ(n) to generate a frequency domain channel estimate Ĥᵢⱼ(k) for a spatial stream transmitted by at least one of a plurality of transmitting antennas j 215a . . . 215n into receiving antenna i.

Various aspects of a method for computing channel estimates in a radio frequency (RF) communications system may comprise decomposing a direct matrix computation into a plurality of constituent matrices, and jointly computing a plurality of channel estimates for a corresponding plurality of channel estimate streams received via a plurality of RF channels based on at least a portion of the plurality of constituent matrices. Aspects of a system for computing channel estimates in an RF communications system may comprise a receiver that decomposes a direct matrix computation into a plurality of constituent matrices, and jointly computes a plurality of channel estimates for a corresponding plurality of channel estimate streams received via a plurality of RF channels based on at least a portion of the plurality of constituent matrices.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing received information in a radio frequency (RF) communications system, the method comprising:
decomposing a direct matrix computation into a plurality of constituent matrices for a plurality of RF channels in a multiple input multiple output (MIMO) system; and
jointly computing a plurality of channel estimates for a corresponding plurality of channel estimate streams received via said plurality of RF channels based on at least a portion of said plurality of constituent matrices.

2. The method according to claim 1, wherein said jointly computing further comprises computing said plurality of channel estimates in parallel.

3. The method according to claim 1, further comprising computing at least a portion of said plurality of channel estimates based on a plurality of symbols received, via at least a portion of said corresponding plurality of channel estimate streams, during a time interval.

4. The method according to claim 3 wherein at least a portion of said plurality of symbols comprises preamble information.

5. The method according to claim 1 further comprising selecting one of said corresponding plurality of channel estimate streams based on a selecting one of said plurality of constituent matrices.

6. The method according to claim 5, further comprising computing a time domain representation of said selected one of said corresponding plurality of channel estimate streams based on an inverse fast Fourier transform (IFFT) one of said plurality of constituent matrices.

7. The method according to claim 5, further comprising generating at least one subsequent channel estimate stream based on said selected one of said corresponding plurality of channel estimate streams.

8. The method according to claim 7, wherein said generated at least one subsequent channel estimate stream is a cyclically shifted version of said selected one of said corresponding plurality of channel estimate streams.

9. The method according to claim 8, further comprising windowing at least one of said selected one of said corresponding plurality of channel estimate streams, and at least one of said generated at least one subsequent channel estimate stream.

10. The method according to claim 9, further comprising computing said jointly computed plurality of channel estimates based on said at least one of said selected one of said corresponding plurality of channel estimate streams, and said at least one of said generated at least one subsequent channel estimate stream.

11. A system for processing received information in a radio frequency (RF) communications system, the system comprising:
a receiver that decomposes a direct matrix computation into a plurality of constituent matrices for a plurality of RF channels in a multiple input multiple output (MIMO) system; and
said receiver jointly computes a plurality of channel estimates for a corresponding plurality of channel estimate streams received via said plurality of RF channels based on at least a portion of said plurality of constituent matrices.

12. The system according to claim 11, wherein said jointly computing further comprises computing said plurality of channel estimates in parallel.

13. The system according to claim 11, wherein said receiver computes at least a portion of said plurality of channel estimates based on a plurality of symbols received, via at least a portion of said corresponding plurality of channel estimate streams, during a time interval.

14. The system according to claim 13 wherein at least a portion of said plurality of symbols comprises preamble information.

15. The system according to claim 11 wherein said receiver selects one of said corresponding plurality of channel estimate streams based on a selecting one of said plurality of constituent matrices.

16. The system according to claim 15, wherein said receiver computes a time domain representation of said selected one of said corresponding plurality of channel estimate streams based on an inverse fast Fourier transform (IFFT) one of said plurality of constituent matrices.

17. The system according to claim 15, wherein said receiver generates at least one subsequent channel estimate stream based on said selected one of said corresponding plurality of channel estimate streams.

18. The system according to claim 17, wherein said generated at least one subsequent channel estimate stream is a cyclically shifted version of said selected one of said corresponding plurality of channel estimate streams.

19. The system according to claim 18, wherein said receiver windows at least one of said selected one of said corresponding plurality of channel estimate streams, and at least one of said generated at least one subsequent channel estimate stream.

20. The system according to claim 19, wherein said receiver computes said jointly computed plurality of channel estimates based on said at least one of said selected one of said corresponding plurality of channel estimate streams, and said at least one of said generated at least one subsequent channel estimate stream.
